(19) United States
(12) Patent Application Publication
(10) Pub. No.: US 2026/0187307 A1
(43) Pub. Date: Jul. 2, 2026

(54) METHODS FOR NUMERICAL SIMULATION OF DISASTER CHAINS FROM LANDSLIDE AND SURGE WAVE TO GLACIER LAKE OUTBURST

(71) Applicant: INSTITUTE OF MOUNTAIN HAZARDS AND ENVIRONMENT, CAS, Chengdu (CN)

(72) Inventors: Jinbo TANG, Chengdu (CN); Peng CUI, Chengdu (CN); Hao WANG, Chengdu (CN); Chunhao WU, Chengdu (CN); Yilong YU, Chengdu (CN); Xubo JIA, Chengdu (CN)

(73) Assignee: INSTITUTE OF MOUNTAIN HAZARDS AND ENVIRONMENT, CAS, Chengdu (CN)

(21) Appl. No.: 19/354,772

(22) Filed: Oct. 9, 2025

(30) Foreign Application Priority Data
Dec. 31, 2024 (CN) 202411981770.9

(51) Int. Cl. G06F 30/20; G06F 111/10; G06V 20/17

(52) U.S. Cl. CPC G06F 30/20; G06V 20/17; G06F 2111/10

(57) ABSTRACT

A numerical simulation method of a disaster chain from landslide and surge wave to glacier lake outburst, including: obtaining simulation data required by a numerical simulation algorithm based on a depth-averaged mixed flow model coupling a continuum mechanics algorithm with a mixed flow. The simulation data includes at least one of topographic data, location of landslide initiation, volume and depth information of the landslide initiation, coarse particles content and fine particles content in an initial stage of the landslide, a friction angle between the landslide and a bed, coarse particles content and fine particles content of the landslide in an erodible channel, water depth distribution of the glacier lake, a bed roughness coefficient of surge and flood evolution, coarse particles content and fine particles content in a moraine dam, and characteristic particle size of the coarse particles and the fine particles in the moraine dam.

### CROSS REFERENCE TO RELATED APPLICATIONS

This application claims priority to Chinese Patent Application No. 202411981770.9, filed on Dec. 31, 2024, the entire contents of which are incorporated herein by reference.

### TECHNICAL FIELD

The present disclosure relates to the field of glacier lake disaster monitoring, and particularly relates to a numerical simulation method of a disaster chain from landslide and surge wave to glacier lake outburst.

### BACKGROUND

Glacier lake outburst is a common natural disaster in alpine regions. Glacial retreat in the alpine regions forms moraine lakes at the leading edge of the glacier, and a large number of landslides are often distributed around these alpine glacier lakes. When the landslides enter into the lake, it produces a strong impact on the lake water, thereby inducing surge waves. When the surge waves travels to moraine dams, the moraine dams are scoured and eroded by the surge waves, causing the moraine dams to be cut, and the glacier lake begins to outburst. Once the glacier lake outbursts, the outburst floods pose a serious threat to the infrastructure and residents' lives downstream of the glacier lake. At present, there is no full-process coupled numerical simulation method for this type of glacier lake outburst disaster chain.

Therefore, it is desirable to propose a numerical simulation method of a disaster chain from landslide and surge wave to glacier lake outburst, which can solve the above problem that there is no full-process coupled numerical simulation method for the glacier lake outburst disaster chain.

### SUMMARY

One or more embodiments of the present disclosure provide a numerical simulation method of a disaster chain from landslide and surge wave to glacier lake outburst, comprising: obtaining simulation data required by a numerical simulation algorithm based on a depth-averaged mixed flow model coupling a continuum mechanics algorithm with a mixed flow, wherein the mixed flow includes a liquid-phase medium, a solid-phase medium, and a gas-phase medium, wherein the solid-phase medium including fine particles and coarse particles, and the simulation data includes at least one of topographic data, a location of landslide initiation, volume and depth information of the landslide initiation, a coarse particles content and a fine particles content in an initial stage of the landslide, a friction angle between the landslide and a bed, a coarse particles content and a fine particles content of the landslide in an erodible channel, a water depth distribution of the glacier lake, a bed roughness coefficient of surge and flood evolution, a coarse particles content and a fine particles content in a moraine dam, and a characteristic particle size of the coarse particles and a characteristic particle size of the fine particles in the moraine dam.

In the present disclosure, the method for the numerical simulation of the disaster chain from the landslide and the surge wave to the glacier lake outburst integrally considers the full-process coupling of the glacier lake outburst disaster chain from the landslide motion to the surge induced by landslide into the lake and then to the glacier lake outburst induced by the surge and the flooding evolution, which successfully achieves the full-process simulation of landslide-induced glacier lake outburst disaster chain, providing technical support for the field of glacier lake outburst.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will be further illustrated by way of exemplary embodiments, which will be described in detail by means of the accompanying figures. These embodiments are not limiting, and in these embodiments, the same numbering denotes the same structure, wherein:

FIG. 1 is an exemplary schematic diagram illustrating a numerical simulation method of a disaster chain from landslide and surge wave to glacier lake outburst according to some embodiments of the present disclosure;

FIG. 2 is an exemplary schematic diagram illustrating a simulation result of numerical simulation of the disaster chain from landslide and surge wave to glacier lake outburst according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that, as used herein, the terms “system”, “device”, “unit” and/or “module” are used herein as a way to distinguish between different components, elements, parts, sections or assemblies at different levels. However, the words may be replaced by other expressions if other words accomplish the same purpose.

As shown in the present disclosure, unless the context clearly suggests an exception, “a”, “an”, “one”, and/or “the” do not refer specifically to the singular, but may also include the plural. In general, the terms “including” and “comprising” only suggest the inclusion of explicitly identified steps and elements that do not constitute an exclusive list, and the method or device may also include other steps or elements.

Flowcharts are used in the present disclosure to illustrate operations performed by a system in accordance with embodiments of the present disclosure. It should be appreciated that the preceding or following operations are not necessarily performed in an exact sequence. Instead, steps can be processed in reverse order or simultaneously. Also, it is possible to add other operations to these processes or remove a step or steps from them.

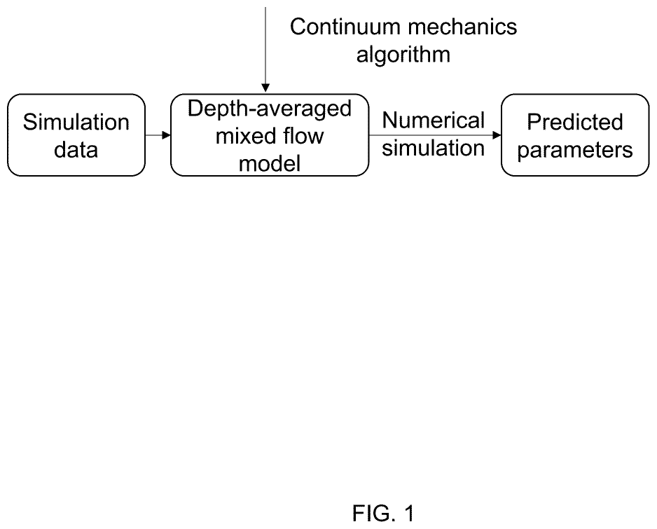

FIG. 1 is an exemplary schematic diagram illustrating a numerical simulation method of a disaster chain from landslide and surge wave to glacier lake outburst according to some embodiments of the present disclosure.

In some embodiments, as shown in FIG. 1, the numerical simulation method of a disaster chain from landslide and surge wave to glacier lake outburst (hereinafter referred to as a numerical simulation method), comprises: obtaining simulation data required by a numerical simulation algorithm based on a depth-averaged mixed flow model coupling a continuum mechanics algorithm with a mixed flow.

In some embodiments, the numerical simulation method may be executed via a processor. In some embodiments, the processor may include a central processing unit (CPU), an application-specific integrated circuit (ASIC), an application-specific instruction processor (ASIP), etc., or any combination of the above.

The landslide and the surge wave refer to phenomena of fluctuation and surge wave on a surface of a water body (e.g., a glacier lake) caused by massive sliding of soil or rock during a landslide event. The landslide and the surge wave may trigger larger scale floods.

The mixed flow refers to a fluid state in which a plurality of media coexist and interact with each other during the landslide process.

In some embodiments, the mixed flow includes a liquid-phase medium, a solid-phase medium, and a gas-phase medium. The liquid-phase medium in the mixed flow includes lake water in the glacier lake, groundwater, etc. The gas-phase medium in the mixed flow includes air, bubbles, etc. that are mixed into the fluid during the landslide process. The solid-phase medium in the mixed flow includes fine particles and coarse particles. The fine particles include solids with small particle sizes such as sand and clay. The coarse particles include solids with large particle sizes such as rocks and moraines.

The depth-averaged mixed flow model refers to a mathematical model that simulates an internal interaction relationship during a motion process of the mixed flow.

In some embodiments, the processor may select a preset continuum mechanics equation as the depth-averaged mixed flow model, to describe the flow of the mixed flow and the motion of the particles. The preset continuum mechanics equation may be set according to requirements, for example, Navier-Stokes equations, continuity equations, etc.

In some embodiments, the depth-averaged mixed flow model includes a mixed flow motion control equation. More descriptions regarding the mixed flow motion control equation may be found in the related descriptions below.

The simulation data refers to data needed for the numerical simulation. In some embodiments, the simulation data includes at least one of topographic data, a location of landslide initiation, volume and depth information of the landslide initiation, a coarse particles content and a fine particles content in an initial stage of the landslide, a friction angle between the landslide and a bed, a coarse particles content and a fine particles content of the landslide in an erodible channel, a water depth distribution of the glacier lake, a bed roughness coefficient of surge and flood evolution, a coarse particles content and a fine particles content in a moraine dam, and a characteristic particle size of the coarse particles and a characteristic particle size of the fine particles in the moraine dam.

The topographic data refers to data that reflects surface characteristic and shape of the target area. The target area refers to an area with a preset range near the glacier lake. The topographic data may be represented by a Digital Elevation Model (DEM).

The location of the landslide initiation refers to an exact location where the glacier lake begins to slide. The location of the landslide initiation may be identified by a geographic coordinate (e.g., latitude and longitude). The volume of the landslide initiation refers to a volume of the landslide mass when the glacier lake begins to slide. The depth information of the landslide initiation refers to a depth from the surface of the landslide mass to the bottom or sliding surface of the landslide mass.

The coarse particles content and the fine particles content at the initial stage of the landslide initiation are a proportion of the coarse particles and a proportion of the fine particles in the mixed flow at the initial stage of the landslide occurrence in the glacier lake.

The friction angle between the landslide and the bed refers to an angle between a landsliding direction of the landslide mass and the bed of the glacier lake. The smaller the friction angle is, the weaker the motion resistance of the landslide mass is, and the more likely the landslide is to occur.

The erodible channel refers to a slope through which the landslide passes. The coarse particles content and the fine particles content of the landslide in the erodible channel are a proportion of the coarse particles and a proportion of fine particles in the erodible channel.

The water depth distribution of the glacier lake is used to describe variation of water depth at different locations within the glacier lake. The water depth affects surge amplitude and flow velocity distribution, etc. of the water body.

The bed roughness coefficient of surge and flood evolution is used to characterize an effect of roughness of a bed surface of a river or a lake on a flow motion characteristic. The higher the bed roughness coefficient is, the greater the resistance to the flow is, and an evolution velocity of the surge and flood evolution may slow down.

The moraine dam refers to a natural dam that is formed by accumulation of deposited gravel, sand, soil, and other materials on the bed of the glacier lake due to the glacial motion. The coarse particles content and the fine particles content in the moraine dam are a proportion of the coarse particles and a proportion of the fine particles in the moraine dam. The characteristic particle size of the coarse particles in the moraine dam refers to a particle size characteristic (e.g., an average particle size and a particle size distribution) of the coarse particles in the moraine dam. The characteristic particle size of the fine particles in the moraine dam refers to a particle size characteristic (e.g., an average particle size and a particle size distribution) of the fine particles in the moraine dam.

In some embodiments, the processor may obtain the simulation data input by a user via a user terminal.

In some embodiments, the processor may obtain the simulation data required for the numerical simulation algorithm based on satellite remote sensing, unmanned aerial vehicle (UAV) aerial survey, and a surface sensor network.

The satellite remote sensing refers to a technology that utilizes sensors (e.g., optical or radar equipment) carried by a satellite to conduct long-range and non-contact observation and data acquisition of the Earth's surface and atmosphere from space. The satellite remote sensing may generate macro-topographic data by periodically scanning and imaging the surface with a large area with the optical or radar equipment.

The UAV aerial survey refers to a technology utilizing drones equipped with high-definition cameras or light detection and ranging (LIDAR) to quickly obtain a three-dimensional model of the surface.

In some embodiments, an implementation process of the UAV aerial survey includes a preparation phase, a data acquisition phase, and a data processing phase.

In some embodiments, in the preparation phase, the target area is imported by a ground software (e.g., DJI GS Pro), operating parameter of the UAV is set, and a flight path is generated based on the ground software; a plurality of target image control points are set in the target area, and three-dimensional (3D) coordinates of the plurality of target image control points are measured by a high-precision global positioning system (e.g., Real-Time Kinematic (RTK)). The target area refers to an area where the numerical simulation is required, for example, an area with a preset range near the glacial lake. The target image control points refer to measurement target points in the target area. The operating parameters of the UAV include a flight altitude, a photo overlap (e.g., along-track, cross-track, etc.), and a flight velocity. The operating parameters of the UAV may be set according to requirements or experience.

In some embodiments, in the data acquisition phase, the processor may upload the flight path generated by the ground software to the UAV, control the UAV to fly autonomously in the target area in accordance with the flight path; and in a flight process, the processor may take a large number of high-definition and high-overlap photographs of the target area at a fixed time or a distance interval via high-definition cameras or LIDAR carried by the UAV.

In some embodiments, in the data processing phase, the processor may import photographs collected by the UAV and the 3D coordinates of the target image control points into the measurement software (e.g., Context Capture, Pix4D, etc.), complete the operations of photo alignment, point cloud generation, and three-dimensional modeling through the measurement software, and finally output the high-precision digital elevation model (DEM) and digital orthophoto map DOM).

The surface sensor network refers to a network formed by the interconnection of monitoring devices deployed at key locations in the target area (e.g., locations of landslides, glacier lake dams, etc.). The monitoring devices include a temperature sensor, a displacement sensor, a pressure sensor, etc. Physical quantities such as a temperature, a displacement, and a pressure at the key locations in the target area may be detected and form into data streams via the surface sensor network. The monitoring devices also include a flow velocity sensor (e.g., an ultrasonic flow velocity sensor, an electromagnetic flow meters, etc.) to monitor a flow velocity (e.g., a first flow velocity and a second flow velocity) during the landslide process. The monitoring devices also include, for example, a water level sensor to monitor water level information (e.g., a flow depth of the mixed flow) during the landslide process.

In some embodiments, the processor may obtain the macro-topographic data output from the satellite remote sensing, the DEM and the DOM output from the UAV aerial survey, etc., as the topographic data required for the numerical simulation algorithm. The processor may obtain the location of the landslide initiation, the volume and the depth information of the landslide initiation, the water depth distribution of the glacier lake, etc., based on the data streams output from the surface sensor network. For example, the processor may take a location where the pressure is greater than a first preset threshold as the location of the landslide initiation.

In some embodiments of the present disclosure, the simulation data required for numerical simulation is synergistically acquired via the satellite remote sensing, the UAV aerial survey, and the surface sensor network, which can provide real-time dynamic basis data for the numerical simulation of the disaster chain from landslide and surge wave to glacier lake outburst, thereby significantly improving reliability, accuracy, and timeliness of the simulation data, and enhancing accuracy of disaster warning and risk assessment.

In some embodiments, as shown in FIG. 1, the processor may input the acquired simulation data into a depth-averaged mixed flow model for the numerical simulation to obtain predicted parameters. The predicted parameters refer to parameters output by the depth-averaged mixed flow model. The predicted parameters include a first unit discharge, a second unit discharge, a first bed resistance, a second bed resistance, a density of the mixed flow, a density of each medium in the mixed flow, a total erosion rate of the mixed flow, and an erosion rate of each medium in the mixed flow, etc. More descriptions may be found in the related descriptions below.

In some embodiments of the present disclosure, combined with continuum mechanics theory, the depth-averaged mixed flow model couples four-phase media such as the water, the coarse particles, the fine particles, and the gas-phase by the continuum mechanics manner, which comprehensively considers the full-process coupling of the disaster chain of the glacier lake outburst from the motion of the landslide to the surge wave induced by landslide into the lake and then to the glacier lake outburst induced by the surge wave and the flood evolution, thereby successfully realizing the full-process simulation of the disaster chain from the landslide to the glacier lake outburst, and providing technical support to the filed of the glacier lake outburst. The data support for numerical simulation is provided by obtaining a plurality of types of simulation data.

In some embodiments, the depth-averaged mixed flow model includes a mixed flow motion control equation.

The mixed flow motion control equation refers to an equation reflecting a relationship between parameters during the motion of the mixed flow.

In some embodiments, the mixed flow motion control equation includes: a first motion equation including a correlation between a first unit discharge of the mixed flow along a first direction, a second unit discharge of the mixed flow along a second direction, and a flow depth of the mixed flow, and a total erosion rate of the mixed flow; a second motion equation including a correlation between the first unit discharge, the second unit discharge, the flow depth of the mixed flow, the total erosion rate of the mixed flow, a density of the mixed flow, a first bed resistance of the mixed flow along the first direction, and a topographic elevation required for simulation; a third motion equation including a correlation of the first unit discharge, the second unit discharge, the depth of the mixed flow, the total erosion rate of the mixed flow, the density of the mixed flow, a second bed resistance of the mixed flow along the second direction, and the topographic elevation required for the simulation.

The first direction refers to a direction in which the river flows. The second direction refers to a direction perpendicular to the direction in which the river flows. The first unit discharge refers to a discharge per unit width (e.g., per meter) of the mixed flow in the first direction. The second unit discharge refers to a discharge per unit width of the mixed flow in the second direction.

In some embodiments, the first unit discharge is related to a first flow velocity of the mixed flow along the first direction and the flow depth of the mixed flow, and the second unit discharge is related to a second flow velocity of the mixed flow along the second direction and the flow depth of the mixed flow.

The flow depth of the mixed flow refers to a vertical distance from the surface of the mixed flow to the bed. The flow depth of the mixed flow, the first flow velocity, and the second flow velocity may be measured by the surface sensor network.

In some embodiments, the first unit discharge is positively correlated with the first flow velocity of the mixed flow along the first direction and the flow depth of the mixed flow, and the second unit discharge is positively correlated with the second flow velocity of the mixed flow along the second direction and the flow depth of the mixed flow. For example, the first unit discharge may be determined by equation (1) and the second unit discharge may be determined by equation (2). Equation (1) and equation (2) are as follows:

$$p = hu , \qquad ( 1 )$$

$$q = hv , \qquad ( 2 )$$

where p denotes the first unit discharge, with a unit of m²/s; q denotes the second unit discharge, with a unit of m²/s; h denotes the flow depth of the mixed flow, with a unit of m; u denotes the flow velocity of the mixed flow along the first direction, with a unit of m/s; and v denotes the flow velocity of the mixed flow along the second direction, with a unit of m/s.

The total erosion rate of the mixed flow reflects the erosion capacity of the mixed flow on the bed. More descriptions regarding the manner of determining the total erosion rate of the mixed flow may be found in the related descriptions below.

The first motion equation reflects the mass conservation of the mixed flow. In some embodiments, the first motion equation may be obtained using a continuity equation (e.g., mass conservation) or experiments.

In some embodiments, the first motion equation may be expressed as equation (3). Equation (3) is shown below:

$$\frac{\partial h}{\partial t} + \frac{\partial p}{\partial x} + \frac{\partial q}{\partial y} = E , \qquad ( 3 )$$

where E denotes the total erosion rate of the mixed flow, with a unit of m/s; t denotes time, with a unit of s; x denotes the first direction; and y denotes the second direction. More descriptions regarding the symbols of equation (3) may be found in equation (1) and equation (2).

The density of the mixed flow is an average density of the mixed flow. The first bed resistance is a resistance generated by the friction of the mixed flow against the bed in the first direction. Topographic elevation required for simulation is elevation data required for numerical simulation. More descriptions regarding the manner of determining the density of the mixed flow, the first bed resistance, and the topographic elevation required for the simulation may be found in the related descriptions below.

The second motion equation reflects momentum conservation of the mixed flow in the first direction. In some embodiments, the second motion equation may be obtained using a continuity equation (e.g., momentum conservation) or experiments.

In some embodiments, the second motion equation may be expressed as equation (4). Equation (4) is as follows:

$$\frac{\partial p}{\partial t} + \frac{\partial }{\partial x} ( \frac{{p}^{2}}{h} ) + \frac{\partial }{\partial y} ( \frac{pq}{h} ) = - gh \frac{\partial ( h + {z}_{b} )}{\partial x} - \frac{{τ}_{bx}}{ρ} - E \frac{p}{h} , \qquad ( 4 )$$

where ρ denotes the density of the mixed flow, with a unit of kg/m³; Tox denotes the first bed resistance, with a unit of Pa; z_{b} denotes the elevation of the terrain required for numerical simulation, with a unit of m; and g denotes a gravitational acceleration, with a unit of m/s². More descriptions regarding the symbols of equation (4) may be found in equations (1)-(3).

The second bed resistance refers to a resistance generated by the friction of the mixed flow against the bed in the second direction.

The third motion equation reflects momentum conservation of the mixed flow in the second direction. In some embodiments, the third motion equation may be obtained using a continuity equation (e.g., momentum conservation) or experiments.

In some embodiments, the third motion equation may be expressed as equation (5). Equation (5) is as follows:

$$\frac{\partial q}{\partial t} + \frac{\partial }{\partial x} ( \frac{pq}{h} ) + \frac{\partial }{\partial y} ( \frac{{q}^{2}}{h} ) = - gh \frac{\partial ( h + {z}_{b} )}{\partial y} - \frac{{τ}_{by}}{ρ} - E \frac{q}{h} , \qquad ( 5 )$$

where τ_{by} denotes the second bed resistance, with a unit of Pa.

In some embodiments of the present disclosure, the complex mechanism of the interaction between the flow and the bed is able to be effectively characterized by establishing the mixed flow motion control equation, thereby improving the physical realism of the simulation.

Erosion degrees of the bed by different media in the mixed flow are different. In order to further reflect the transfer of each medium in the mixed flow, the numerical simulation may be performed by the following algorithm.

In some embodiments, the processor may determine an erosion rate of the liquid-phase medium based on the flow depth of the mixed flow, the first unit discharge, the second unit discharge, and a volume fraction of the liquid-phase medium in the mixed flow; determine an erosion rate of the solid-phase medium based on the flow depth of the mixed flow, the first unit discharge, the second unit discharge, and a volume fraction of the solid-phase medium in the mixed flow; and determine an erosion rate of the gas-phase medium based on the flow depth of the mixed flow, the first unit discharge, the second unit discharge, a volume fraction of the gas-phase medium in the mixed flow, and an overflow velocity of the gas-phase medium in the mixed flow.

The volume fraction of the liquid-phase medium refers to a volume percentage of the liquid-phase medium in the mixed flow. The volume fraction of the liquid-phase medium may be estimated by manual sampling.

The erosion rate of the liquid-phase medium refers to a degree of erosion of the bed by the liquid-phase medium (e.g., water) per unit of time during the motion of the mixed flow. In some embodiments, the erosion rate of the liquid-phase medium may be calculated by equation (6). Equation (6) is as follows:

$$\frac{\partial ( h {ϕ}_{w} )}{\partial t} + \frac{\partial ( {ϕ}_{w} p )}{\partial x} + \frac{\partial ( {ϕ}_{w} q )}{\partial y} = {E}_{w} , \qquad ( 6 )$$

where φ_{w} denotes the volume fraction of water in the mixed flow, with dimensionless; and E_{w} denotes the erosion rate of the liquid-phase medium, with a unit of m/s.

The volume fraction of the solid-phase medium refers to a volume percentage of the solid-phase medium in the mixed flow. The volume fraction of the solid-phase medium may be estimated by manual sampling.

The erosion rate of the solid-phase medium refers to a degree of erosion of the bed by the solid-phase medium per unit of time during the motion of the mixed flow. The erosion rate of the solid-phase medium includes the erosion rate of the fine particles and the erosion rate of the coarse particles. In some embodiments, the erosion rate of fine particles may be calculated by equation (7) and the erosion rate of the coarse particles may be calculated by equation (8). Equation (7) and equation (8) are as follows:

$$\frac{\partial ( h {ϕ}_{f} )}{\partial t} + \frac{\partial ( {ϕ}_{f} p )}{\partial x} + \frac{\partial ( {ϕ}_{f} q )}{\partial y} = {E}_{f} , \qquad ( 7 )$$

$$\frac{\partial ( h {ϕ}_{c} )}{\partial t} + \frac{\partial ( {ϕ}_{c} p )}{\partial x} + \frac{\partial ( {ϕ}_{c} q )}{\partial y} = {E}_{c} , \qquad ( 8 )$$

where φ_{f} denotes the volume fraction of fine particles in the mixed flow, with dimensionless; φ_{c} denotes the volume fraction of coarse particles in the mixed flow, with dimensionless; E_{f} denotes the erosion rate of fine particles, with a unit of m/s; and E_{c} denotes the erosion rate of coarse particles, with a unit of m/s.

The volume fraction of the gas-phase medium refers to a volume percentage of the gas-phase medium in the mixed flow. The volume fraction of the gas-phase medium may be estimated by manual sampling. The overflow velocity of the gas-phase medium refers to a velocity at which the gas-phase medium (e.g., the air or the bubbles) in the mixed flow escapes from the mixed flow.

The erosion rate of the gas-phase medium refers to a degree of erosion of the bed by the solid-phase medium per unit of time during the motion of the mixed flow. In some embodiments, the erosion rate of the gas-phase medium may be calculated by equation (9). Equation (9) is as follows:

$$\frac{\partial ( h {ϕ}_{a} )}{\partial t} + \frac{\partial ( {ϕ}_{a} p )}{\partial x} + \frac{\partial ( {ϕ}_{a} q )}{\partial y} = {E}_{a} - {u}_{a} , \qquad ( 9 )$$

where φₐ denotes the volume fraction of air in the mixed flow, with dimensionless; Eₐ denotes the erosion rate of air during motion of the mixed flow, with a unit of m/s; and uₐ denotes the overflow velocity of air in the mixed flow, with a unit of m/s.

By calculating the erosion rates of a plurality of media, it is possible to gain a deep understanding of the effects of fluid dynamics on different particles, providing a reliable data basis for the depth-averaged mixed flow model, thus improving the accuracy of the numerical simulation.

In some embodiments, the processor may determine an erosion rate of the gas-phase medium in the mixed flow based on the total erosion rate of the mixed flow and a volume fraction of the gas-phase medium in an erodible channel bed.

The erodible channel bed refers to an area of the bed that is susceptible to scouring and damage under the action of water flow. The area in which the erodible channel bed is located may be obtained experimentally or through field monitoring.

In some embodiments, the erosion rate of the gas-phase medium in the mixed flow may be calculated by Equation (10). Equation (10) is as follows:

$${E}_{a} = {α}_{ba} E , \qquad ( 10 )$$

where α_{ba} denotes the volume fraction of the gas-phase medium in the erodible channel bed.

In some embodiments, the processor may determine an erosion rate of the fine particles in the mixed flow based on the total erosion rate of the mixed flow and a volume fraction of the fine particles in the erodible channel bed.

In some embodiments, the erosion rate of the fine particles in the mixed flow may be calculated by equation (11). Equation (11) is as follows:

$${E}_{f} = {α}_{bf} E , \qquad ( 11 )$$

where α_{bf} denotes the volume fraction of the fine particles in the erodible channel bed.

In some embodiments, the processor may determine an erosion rate of the coarse particles in the mixed flow based on the total erosion rate of the mixed flow and a volume fraction of the coarse particles in the erodible channel bed.

In some embodiments, the erosion rate of coarse particles in the mixed flow may be calculated by equation (12). Equation (12) is as follows:

$${E}_{c} = {α}_{bc} E , \qquad ( 12 )$$

wherein α_{bc} denotes the volume fraction of the coarse particles in the erodible channel bed.

In some embodiments, the processor may determine an erosion rate of the liquid-phase medium in the mixed flow based on the total erosion rate of the mixed flow and a volume fraction of the liquid-phase medium in the erodible channel bed.

In some embodiments, the erosion rate of the liquid-phase medium in the mixed flow may be calculated by equation (13). Equation (13) is as follows:

$${E}_{w} = {α}_{bw} E , \qquad ( 13 )$$

where α_{bw} denotes the volume fraction of the liquid-phase medium in the erodible channel bed.

By evaluating the erosion rates of the gas-phase medium, the fine particles, and the coarse particles, a comprehensive description of the physical mechanisms is provided, which helps to optimize the parameter settings of the flood and landslide models, thus enhancing the accuracy of the simulations and improving the ability to assess potential risks.

In some embodiments, the processor may determine a preliminary prediction result of landslide risk in a target area based on initial topographic data of the target area and a landslide material content in a landslide mass; generate an aerial survey instruction in response to the preliminary prediction result being that the target area includes a risk area; and control an UAV to conduct aerial survey on the risk area based on the aerial survey instruction, collect particle size distribution data of at least one of the fine particles and the coarse particles in the risk area, and update parameters of the depth-averaged mixed flow model.

The initial topographic data refers to initially acquired topographic data within the target area. In some embodiments, the initial topographic data may be acquired via the satellite remote sensing. In some embodiments, the initial topographic data may be in the form of a raster data map including a plurality of grids. The grid size may be set empirically.

The landslide material content refers to a preliminary quantitative assessment result of the content of particles with different particle sizes (e.g., the fine particles content, the coarse particles content, etc.) within the landslide mass.

In some embodiments, the landslide material content may be determined by field sampling. For example, the processor may divide the target area into a plurality of sample partitions, sample each of the plurality of sample partitions, estimate the coarse particles content based on sampled samples, and determine a type of the sample partition based on an estimation result. The type of the sample partition includes a high coarse particles partition, a medium coarse particles partition, and a low coarse particles partition. The high coarse particles partition refers to a partition in which a coarse particles volume percentage is greater than or equal to a first preset threshold. The medium coarse particles partition refers to a partition in which the coarse particles volume percentage is between the first preset threshold and a second preset threshold. The low coarse particles partition refers to a partition in which the coarse particle volume percentage is less than or equal to the second preset threshold. The first preset threshold is greater than the second preset threshold, e.g., the first preset threshold is 60% and the second preset threshold is 30%. The partition size of the sample partition may be set based on manual experience.

The preliminary prediction result refers to a parameter used to assess the landslide risk in the target area. The preliminary prediction result includes a prediction result of the risk area.

The risk area refers to an area where there is a potential risk of landslide hazard, for example, landslide-prone areas, fragile sections of gullies, etc.

In some embodiments, the processor may determine the preliminary prediction result based on the initial topographic data and the landslide material content by operations 110-130 below.

In 110, the initial topographic data is input into a geographic information system (GIS) software (e.g., QGIS, ArcGIS, etc.) to calculate slopes of a plurality of grids occupied by the target area in the raster data map; and a landslide risk score is assigned to each of the grids based on the slopes to obtain a topographic risk map.

The topographic risk map refers to a scoring map reflecting the risk of landslide due to slope in the target area.

In some embodiments, the landslide risk score is positively correlated with the slope, and a higher value of the landslide risk score indicates a higher landslide risk.

In 120, a loose risk score is assigned to each grid corresponding to the target area based on the landslide material content to obtain a material risk map.

The material risk map is a score map reflecting the degree of looseness of the soil in the target area.

The loose risk score is positively correlated with the volume of the coarse particles. For example, if the grid is located in the high coarse particles partition, the loose risk score is 3; if the grid is located in the medium coarse particles partition, the loose risk score is 2; if the grid is located in the low coarse particles partition, the loose risk score is 1.

In 130, the risk area is determined based on the topographic risk map and the material risk map.

In some embodiments, when the grid sizes divided in the topographic risk map and the material risk map are the same, the processor may align the grids of the topographic risk map and the material risk map; determine a sum of the landslide risk score and the loose risk score of each grid as a risk level of the grid; and identify the grids whose risk level greater than or equal to a preset threshold as the risk area.

The aerial survey instruction refers to an operation instruction that controls the UAV to perform mapping data collection according to the operating parameters.

The particle size distribution data includes a spatial distribution characteristic and percentages of particles with different particle sizes in the risk area.

In some embodiments, the LIDAR and a hyperspectral sensor carried by the UAV performs a low-altitude (e.g., 50-100 m) fine scanning of the risk area, and the processor may communicate with the UAV to obtain an ultra-high resolution orthophoto. The processor may import the ultra-high resolution orthophoto into the GIS software for gridding processing and divide the risk area into multiple grids. The grid size may be set based on manual experience, e.g., 5 meters×5 meters. At least a portion (e.g., 10%-20%) of the grids was randomly selected as a sample grid, and a coverage area percentage of the coarse particles and a coverage area percentage of the fine particles within the sample grid are determined as attribute values of the sample grid. Coverage area percentages of the coarse particles and coverage area percentages of the fine particles for all grids in the risk area are determined based on the attribute values of the sample grids via an interpolation manner (e.g., inverse distance weight interpolation), and a coverage rate distribution map is generated.

During the numerical simulation, when a target point selected for numerical simulation is located in the risk area, the processor may directly extract the coverage area percentage of the coarse particles and the coverage area percentage of the fine particles of the grid in which the target point is located from the coverage rate distribution map as the volume fraction of the coarse particles and the volume fraction of the fine particles, and update the parameters in the depth-averaged mixed flow model. The target point refers to a point in the target area that needs to be numerically simulated.

In some embodiments of the present disclosure, the parameters of the depth-averaged mixed flow model are dynamically updated by preliminarily predicting the risk area and controlling the UAV to acquire data by aerial survey, which can improve the simulation accuracy under complex material conditions and enhance the reliability of the risk identification, providing efficient and precise technical support for landslide disaster early warning. At the same time, resources can be saved by accurately placing aerial survey resources in key risk area.

In some embodiments, the processor may determine the topographic elevation required for simulation based on the total erosion rate of the mixed flow.

In some embodiments, a change rate of the topographic elevation over time is negatively correlated with the total erosion rate of the mixed flow.

In some embodiments, the topographic elevation may be calculated by equation (14), which is as follows:

$$\frac{\partial {z}_{b}}{\partial t} = - E , \qquad ( 14 )$$

more descriptions regarding the symbols of equation (14) may be found in equations (3) and (4).

By determining the topographic elevation based on the total erosion rate of the mixed flow, the simulation parameters can be dynamically adjusted to adapt to the constantly evolving environmental conditions, so that the changes in the terrain can be efficiently reflected in model predictions, and the credibility of the numerical simulation results can be improved.

In some embodiments, the processor may determine the density of the mixed flow based on a density and a volume fraction of the liquid-phase medium, a density and a volume fraction of the solid-phase medium, and a density and a volume fraction of the gas-phase medium in the mixed flow.

The density of the liquid-phase medium refers to a density of the liquid-phase medium in the mixed flow, for example, a density of water.

The density of a solid-phase medium refers to a density of a solid-phase medium in the mixed flow, for example, an average density of the coarse particles and the fine particles. The density of the solid-phase medium may be determined empirically or by sampling measurements.

The density of the gas-phase medium refers to a density of the gas-phase medium in the mixed flow, for example, a density of air.

In some embodiments, the density of the mixed flow is positively correlated with the density and volume fraction of the liquid-phase medium, the density and volume fraction of the solid-phase medium, and the density and volume fraction of the gas-phase medium.

In some embodiments, the density of the mixed flow may be calculated by equation (15). Equation (15) is as follows:

$$ρ = {ϕ}_{w} {ρ}_{w} + {ϕ}_{f} {ρ}_{s} + {ϕ}_{c} {ρ}_{s} + {ϕ}_{a} {ρ}_{a} , \qquad ( 15 )$$

where ρ_{w} denotes the density of water, taking a value of 1000 with a unit of kg/m³; ρₛ denotes the density of the coarse particles and the fine particles, taking a value of 2650 with a unit of kg/m³, and Pa denotes the density of the air, taking a value of 1.29 with a unit of kg/m³.

Accurately calculating the density of the mixed flow based on the density and volume fraction of each medium in the mixed flow can improve the model's ability to describe the flow characteristics, which enables the model to better deal with the complex fluid characteristics and the interactions of different media.

In some embodiments, the processor may determine a first bed resistance of the mixed flow along the first direction based on the density of the mixed flow, a first conversion parameter when flood transitions to underwater saturated landslide or debris flow, a first motion resistance of a fine particle mixture along the first direction, a second motion resistance of the coarse particles along the first direction, a Manning coefficient, the first unit discharge, and the second unit discharge.

The first conversion parameter refers to a resistance conversion coefficient when flood transitions to the underwater saturated landslide or the debris flow.

In some embodiments, the first conversion parameter is related to a volume fraction of the fine particles in the mixed flow, a volume fraction of the coarse particles in the mixed flow, a critical total particle concentration, and a first attenuation parameter when the flood transitions to the underwater saturated landslide or the debris flow.

The critical total particle concentration refers to a minimum concentration at the boundary between the underwater saturated landslide or the debris flow and the flood. The critical total particle concentration may be set empirically, for example, the critical total particle concentration is 0.18.

The first attenuation parameter reflects a rate at which particles dissipate or attenuate when the flood transitions to the underwater saturated landslide or the debris flow. The first attenuation parameter may be set empirically, for example, the first attenuation parameter is 13.8.

In some embodiments, the first conversion parameter may be calculated by equation (16). Equation (16) is as follows:

$$Γ = {e}^{- {α}_{Γ} \frac{{ϕ}_{f} + {ϕ}_{c}}{{ϕ}_{g \_ c}}} , \qquad ( 16 )$$

where Γ denotes the first conversion parameter, with dimensionless; φ_{g_c} denotes the critical total particle concentration, with dimensionless, taking a value of 0.18, and α_{Γ} denotes the first attenuation parameter, with dimensionless, taking a value of 13.8.

The first motion resistance refers to a frictional resistance generated between the fine particle mixture and the bed in the first direction during the motion of the mixed flow. The second motion resistance refers to a frictional resistance generated between the coarse particles and the bed in the first direction during the motion of the mixed flow. More descriptions regarding the manner of determining the first motion resistance and the second motion resistance may be found in the related descriptions below.

In some embodiments, the fine particle mixture includes the fine particles, the liquid-phase medium (e.g., water), and the gas-phase medium (e.g., the air and the bubbles).

The Manning coefficient refers to an empirical coefficient used to characterize a surface roughness of open channels. The Manning coefficient is related to material of the bed, which may be determined by consulting a relevant engineering manual or a specification.

In some embodiments, the first bed resistance may be determined by equation (17). Equation (17) is as follows:

$${τ}_{bx} = \frac{ρ {gn}^{2} p \sqrt{{p}^{2} + {q}^{2}}}{{h}^{7 / 3}} Γ + [ ( 1 - {ϕ}_{c} ) {τ}_{fx} + {ϕ}_{c} {τ}_{cx} ) ( 1 - Γ ) , \qquad ( 17 )$$

where τ_{fx} denotes the first motion resistance, with a unit of Pa; τ_{cx} denotes the second motion resistance, with a unit of Pa; and n denotes the Manning coefficient, with a unit of s/m^{1/3}.

In some embodiments, the processor may and determine the second bed resistance of the mixed flow along the second direction based on the density of the mixed flow, a transition conversion parameter, a third motion resistance of the fine particle mixture along the second direction, a fourth motion resistance of the coarse particles along the second direction, the Manning coefficient, the first unit discharge, and the second unit discharge.

The third motion resistance refers to a frictional resistance generated between the fine particle mixture and the bed in the second direction during the motion of the mixed flow. The fourth motion resistance refers to a frictional resistance generated between the coarse particles and the bed in the second direction during the motion of the mixed flow. More descriptions regarding the manner of determining the third motion resistance and the fourth motion resistance may be found in the related descriptions below.

In some embodiments, the second bed resistance may be determined by equation (18). Equation (18) is as follows:

$${τ}_{by} = \frac{ρ {gn}^{2} q \sqrt{{p}^{2} + {q}^{2}}}{{h}^{7 / 3}} Γ + [ ( 1 - {ϕ}_{c} ) {τ}_{fy} + {ϕ}_{c} {τ}_{cy} ] ( 1 - Γ ) , \qquad ( 18 )$$

where τ_{fy} denotes the third motion resistance, with a unit of Pa; and τ_{cy} denotes the fourth motion resistance, with a unit of Pa.

In some embodiments, the first motion resistance and the third motion resistance are related to the volume fraction and the density of the fine particles in the mixed flow, the volume fraction and the density of the liquid-phase medium in the mixed flow, the volume fraction and the density of the gas-phase medium in the mixed flow, the first unit discharge, the second unit discharge, the first flow velocity, the second flow velocity, the flow depth of the mixed flow, a suction stress between unsaturated fine particles, a cohesion between the unsaturated fine particles, a first friction angle, and a second conversion parameter for resistance conversion from unsaturated landslide to saturated landslide, respectively.

The first friction angle refers to a friction angle between the unsaturated fine particles in the mixed flow and the bed.

The suction stress between unsaturated fine particles refers to a force between the fine particles in the unsaturated state due to the presence of water and surface tension. The cohesion between unsaturated fine particles refers to a force of mutual attraction between fine particles in the unsaturated state due to interaction.

The second conversion parameter refers to a coefficient of resistance conversion from unsaturated to saturated landslides.

In some embodiments, the processor may determine the second conversion parameter based on the volume fraction of the gas-phase medium in the mixed flow, a critical gas-phase volume fraction, and a second attenuation parameter for resistance conversion from the unsaturated landslide to the saturated landslide.

The critical gas-phase volume fraction refers to a volume fraction of the gas-phase medium in the mixed flow when the landslide is just saturated. The critical gas-phase volume fraction may be set empirically. For example, the critical gas-phase volume fraction is 0.001.

The second attenuation parameter reflects a rate at which the resistance dissipates or attenuates from the unsaturated landslide to the saturated landslide. The second attenuation parameter may be set empirically. For example, the second attenuation parameter is 13.8.

In some embodiments, the second conversion parameter may be calculated by equation (19). Equation (19) is as follows:

$$K = {e}^{- {α}_{K} \frac{ϕ a}{{ϕ}_{a \_ c}}} , \qquad ( 19 )$$

where K denotes the second conversion parameter, with dimensionless, α_{K} denotes the second attenuation parameter, with dimensionless; and φ_{a_c} denotes the critical gas-phase volume fraction, with dimensionless.

In some embodiments, the processor may determine the suction stress between the unsaturated fine particles based on a volumetric water content, a residual water content, and a saturated water content between the fine particles.

The volumetric water content between the fine particles refers to a ratio of the volume of water contained between the fine particles to a total volume of the fine particles.

In some embodiments, the volumetric water content between the fine particles is related to the volume fraction of the liquid-phase medium, the volume fraction of the fine particles, and the volume fraction of the gas-phase medium in the mixed flow.

In some embodiments, the volumetric water content between the fine particles may be calculated by equation (20). Equation (20) is as follows:

$${θ}_{f} = \frac{{ϕ}_{w}}{{ϕ}_{f} + {ϕ}_{w} + {ϕ}_{a}} , \qquad ( 20 )$$

where θ_{f} denotes the volumetric water content between the fine particles, with dimensionless.

Th residual water content between the fine particles refers to a ratio of a volume of water retaining between fine particles to the total volume of fine particles after the fine particles undergo water loss or drainage.

The saturated water content between the fine particles refers to a ratio of the volume of water to the total volume of the fine particles when the fine particles are filled with water. The residual water content and the saturated water content may be obtained empirically or experimentally.

In some embodiments, the suction stress between the unsaturated fine particles may be calculated by equation (21). Equation (21) is as follows:

$${σ}_{s} = - \frac{1}{{α}_{σ}} {\frac{{θ}_{f} - {θ}_{f \_ r}}{{θ}_{f \_ s} - {θ}_{f \_ r}} [ {( \frac{{θ}_{f \_ s} - {θ}_{f \_ r}}{{θ}_{f} - {θ}_{f \_ r}} )}^{1 / m} - 1 ]}^{1 / n ′} , \qquad ( 21 )$$

where σₛ denotes the suction stress between the unsaturated fine particles, with a unit of Pa; m and α_{σ} denote empirical coefficients for calculating the suction stress, which may be set empirically, with dimensionless; θ_{f} denotes the volumetric water content between the fine particles, with dimensionless; θ_{f_r} denotes the residual water content between the fine particles, with dimensionless; θ_{f_s} denotes the saturated water content between the fine particles, with dimensionless; and

$${n}^{′} = \frac{1}{1 - m} ,$$

with dimensionless.

In some embodiments of the present disclosure, by determining the second conversion parameter and the suction stress between the unsaturated fine particles, it can analyze the conversion of the resistance from unsaturated landslide to saturated landslide and the effect of the water content of the fine particles on the suction stress, thereby providing more accurate data support for the model.

In some embodiments, the first motion resistance may be calculated by equation (22) and the third motion resistance may be calculated by equation (23). Equation (22) and equation (23) are as follows:

$${τ}_{fx} = K \{ {α}_{1} exp ( {β}_{1} \frac{{ϕ}_{f}}{{ϕ}_{w} + {ϕ}_{f}} ) \frac{p}{\sqrt{{p}^{2} + {q}^{2}}} + 3 {α}_{2} exp ( {β}_{2} \frac{{ϕ}_{f}}{{ϕ}_{w} + {ϕ}_{f}} ) \frac{p}{{h}^{2}} \} + ( 1 - K ) \{ [ \frac{{ϕ}_{f} {ρ}_{s} + {ϕ}_{w} {ρ}_{w} + {ϕ}_{a} {ρ}_{a}}{{ϕ}_{f} + {ϕ}_{w} + {ϕ}_{a}} gh - {σ}_{s} ] tan {φ}_{f} + c \} \frac{p}{\sqrt{{p}^{2} + {q}^{2}}} , \qquad ( 22 )$$

$${τ}_{fy} = K \{ {α}_{1} exp ( {β}_{1} \frac{{ϕ}_{f}}{{ϕ}_{w} + {ϕ}_{f}} ) \frac{q}{\sqrt{{p}^{2} + {q}^{2}}} + 3 {α}_{2} exp ( {β}_{2} \frac{{ϕ}_{f}}{{ϕ}_{w} + {ϕ}_{f}} ) \frac{q}{{h}^{2}} \} + ( 1 - K ) \{ [ \frac{{ϕ}_{f} {ρ}_{s} + {ϕ}_{w} {ρ}_{w} + {ϕ}_{a} {ρ}_{a}}{{ϕ}_{f} + {ϕ}_{w} + {ϕ}_{a}} gh - {σ}_{s} ] tan {φ}_{f} + c \} \frac{q}{\sqrt{{p}^{2} + {q}^{2}}} , \qquad ( 23 )$$

where ρₛ denotes the density of the fine particles, taking a value of 2650, with a unit of kg/m³; c denotes the cohesion between the unsaturated fine particles, with a unit of Pa; φ_{f} denotes the first friction angle, with a unit of °; α₁, α₂, β₁, and β₂ denote empirical coefficients that may be set empirically. α₁ is in a range of 7.0×10⁻⁴-2.6, β₁, β₁ is in a range of 7.8-29.8, α₂ is in a range of 7.0×10⁻⁴-2.9×10⁻¹, β₂ is in a range of 6.2-36.6.

In some embodiments of the present disclosure, by determining the bed resistance based on various hydrodynamic parameters, it improves the accuracy of the model in describing the different media in fluid motion. By considering a variety of motion resistances, the flow behavior of the mixed flow under different conditions can be efficiently simulated, which provides an important basis for disaster prediction and prevention and control.

In some embodiments, the processor may determine the third motion resistance based on the density of the mixed flow, a density of the fine particle mixture, the first unit discharge, the second unit discharge, the first flow velocity, the second flow velocity, the depth of the mixed flow, a first slope of the mixed flow along the first direction, a second friction angle between the coarse particles in the mixed flow and the bed, a volume fraction and a turbulence coefficient of the coarse particles, and a density of the fine particles.

The density of the fine particle mixture refers to an average density of the fine particle mixture (including the fine particles, the water, and the gas) in the mixed flow.

In some embodiments, the density of the fine particle mixture is related to the density and a volume fraction of the fine particles, the density and the volume fraction of the liquid-phase medium, and the density and the volume fraction of the gas-phase medium.

In some embodiments, the density of the fine particle mixture may be calculated by equation (24). Equation (24) is as follows:

$${ρ}_{f} = \frac{{ϕ}_{f} {ρ}_{s} + {ϕ}_{w} {ρ}_{w} + {ϕ}_{a} {ρ}_{a}}{{ϕ}_{f} + {ϕ}_{w} + {ϕ}_{a}} , \qquad ( 24 )$$

where ρ_{f} denotes the density of the fine particle mixture, with a unit of kg/m³.

The first slope refers to a slope of the mixed flow with respect to the horizontal plane in the first direction.

The second friction angle refers to an angle of friction between the coarse particles and the bed during the motion of the mixed flow.

The turbulence coefficient of the coarse particles refers to a coefficient that reflects the intensity of the motion and the turbulent mixing degree of coarse particles in the mixed flow.

In some embodiments, the third motion resistance may be calculated by equation (25). Equation (25) is as follows:

$${τ}_{cx} = ( ρ - {ρ}_{f} ) gh cos {θ}_{x} tan {φ}_{s} \frac{p}{\sqrt{{p}^{2} + {q}^{2}}} + {ϕ}_{c} {ρ}_{s} g \frac{p \sqrt{{p}^{2} + {q}^{2}}}{{h}^{2} {C}_{z}^{2}} , \qquad ( 25 )$$

where θₓ denotes the first slope, with a unit of °; φₛ denotes the second friction angle, with a unit of °; and C_{z} denotes the turbulence coefficient of the coarse particles in the mixed flow, with a unit of m^{1/2}/s.

In some embodiments, the processor may determine the fourth motion resistance based on the density of the mixed flow, the density of the fine particle mixture, the first unit discharge, the second unit discharge, the first flow velocity, the second flow velocity, the flow depth of the mixed flow, a second slope of the mixed flow along the second direction, the second friction angle, the volume fraction and the turbulence coefficient of the coarse particles, and the density of the fine particles.

The second slope refers to a slope of the mixed flow with respect to the horizontal plane in the second direction.

In some embodiments, the fourth motion resistance may be calculated by equation (26). Equation (26) is as follows:

$${τ}_{cy} = ( ρ - {ρ}_{f} ) gh cos {θ}_{y} tan {φ}_{s} \frac{q}{\sqrt{{p}^{2} + {q}^{2}}} + {ϕ}_{c} {ρ}_{s} g \frac{q \sqrt{{p}^{2} + {q}^{2}}}{{h}^{2} {C}_{z}^{2}} , \qquad ( 26 )$$

where θ_{y} denotes the second slope, with a unit of °.

In some embodiments of the present disclosure, by comprehensively analyzing the motion resistance of fine particle mixture and coarser particles, it can improve the adaptability of the model to complex flow states, making the analysis and prediction of flow characteristics more effective in practical applications, further optimizing flood risk management.

In some embodiments, the processor may determine the total erosion rate of the mixed flow based on the flow depth of the mixed flow, the density of the mixed flow, the first bed resistance, the second bed resistance, the first flow velocity, the second flow velocity, the first unit discharge, the second unit discharge, a pore water pressure ratio, a channel bed slope of the mixed flow, and a friction angle and a cohesion of bed particles.

The pore water pressure ratio refers to a ratio of a pore water pressure in the bed particles to a total pressure of the bed particles.

The channel bed slope of the mixed flow refers to a inclination angle of the channel bed of the mixed flow with respect to the horizontal plane. The channel bed refers to a bottom region where a motion path of the mixed flow is located, i.e., the lowest layer of the channel. The channel bed includes solid material (e.g., soil, rock, sediment) at the bottom of the channel and the mixed flow that is flowing.

In some embodiments, the channel bed slope of the mixed flow is related to a third slope of the bed along the first direction and a fourth slope of the bed along the second direction.

In some embodiments, the channel bed slope of the mixed flow may be calculated by equation (27) as follows:

$$θ = arctan ( \sqrt{{tan}^{2} {θ}_{x} + {tan}^{2} {θ}_{y}} ) , \qquad ( 27 )$$

where θ denotes the channel bed slope of the mixed flow, with a unit of °; θₓ denotes the third slope, with a unit of °; and θ_{y} denotes the fourth slope, with a unit of °.

The third slope refers to a inclination angle of the bed with respect to the horizontal plane in the first direction. The fourth slope refers to a inclination angle of the bed with respect to the horizontal plane in the second direction.

In some embodiments, the third slope and the fourth slope are related to a grid size and a topographic elevation of a grid.

In some embodiments, the grid size includes a size of the grid in the first direction and a size of the grid in the second direction. The topographic elevation of the grid refers to a topographic elevation of the grid on the topographic map. More descriptions regarding the grid division may be found in the related descriptions above.

In some embodiments, the third slope may be calculated by equation (28) and the fourth slope may be calculated by equation (29). Equations (28) and (29) are as follows:

$${θ}_{x} = arctan \vert \frac{{z}_{b ( i + 1 , j )} - {z}_{b ( i , j )}}{Δ x} \vert , \qquad ( 28 )$$

$${θ}_{y} = arctan \vert \frac{{z}_{b ( i , j + 1 )} - {z}_{b ( i , j )}}{Δ y} \vert , \qquad ( 29 )$$

where z_{b(i,j)} denotes a topographic elevation of the numbered grid (i, j), with a unit of m;
z_{b(i+1,j)} denotes a topographic elevation of the numbered grid (i+1, j), with a unit of m;
z_{b(i,j+1)} denotes a topographic elevation of the numbered grid (i, j+1), with a unit of m;
Δx denotes the size of the grid in the first direction, with a unit of m; Δy denotes the size of the grid in the second direction, with a unit of m.

The friction angle of the bed particles refers to an angle between a friction force and a normal force generated by the interaction of particles located in the bed. The cohesion of the bed particles refers to an attraction force between particles located in the bed due to intrinsic physical or chemical interactions. The bed refers to a solid surface of the channel bed.

In some embodiments, the total erosion rate of the mixed flow may be calculated by equation (30). Equation (30) is as follows:

$$E = \frac{\sqrt{{τ}_{bx}^{2} + {τ}_{by}^{2}} - [ ρ gh cos θ ( 1 - λ ) tan {φ}_{bed} + C ]}{ρ \sqrt{{u}^{2} + {v}^{2}}} , \qquad ( 30 )$$

where λ denotes the pore water pressure ratio, with dimensionless; φ_{bed} denotes the friction angle of the bed particles, with a unit of °; and C denotes the cohesion of the bed particles, with a unit of Pa.

In some embodiments of the present disclosure, by combining a variety of flow parameters to calculate the total erosion rate, it can comprehensively assess the impact of the mixed flow on the bed, thus providing reliable data support for model and risk assessment.

In some embodiments, the processor may determine whether a risk exists based on a simulation result of the depth-averaged mixed flow model; generate an actual simulation instruction in response to an existence of the risk; send the practical simulation instruction to a 3D printing device, control the 3D printing device to produce a physical simulation sand table, and perform a hydraulic simulation based on the physical simulation sand table to verify the existence of the risk; and adjust the cohesion of the bed particles and the pore water pressure ratio based on surge erosion characteristics observed in the hydraulic simulation.

The simulation result refers to a test result from the numerical simulation based on the depth-averaged mixed flow model.

In some embodiments, the processor may obtain the DEM of the target area acquired by the UAV and updated parameters of the depth-averaged mixed flow model; perform at least one numerical simulation under a hazardous scenario based on an updated depth-averaged mixed flow model to obtain the simulation result; obtain the minimum elevation of the moraine dam and a downstream flood peak discharge from the simulation result; and determine whether there is a risk based on the minimum elevation of the moraine dam and the downstream flood peak discharge.

The minimum elevation of the moraine dam refers to an elevation of the lowest point of a crest of the moraine dam under the erosion of landslide in the simulation process.

The downstream flood peak discharge refers to a maximum instantaneous discharge of flood passing through a critical downstream section after the outburst. The critical downstream section may be an upstream of a village, a town, etc.

In some embodiments, the risk includes a dam failure risk, a flood risk.

In some embodiments, the processor may determine that the dam failure risk exists in response to a determination that the minimum elevation of the moraine dam obtained from the numerical simulation is lower than a preset elevation. In some embodiments, the processor may determine that a flood risk exists in response to a determination that the downstream flood peak discharge exceeds a safe flood discharge. The preset elevation and the safe flood discharge may be set based on manual experience.

The actual simulation instruction refers to an instruction that controls the 3D printing device to print the physical simulation sand table.

The 3D printing device may be an industrial-grade 3D printer. The physical simulation sand table refers to a physical platform used to reproduce the process of landslide surge inducing glacier lake outburst.

The hydraulic simulation refers to an experiment to simulate and analyze the whole process of the disaster chain from landslide and surge wave to glacier lake outburst through a physical simulation sand table.

In some embodiments, the process of producing the physical simulation sand table for the actual hydraulic simulation of the outburst flood may include following operations. The processor may export the initial topographic data and the simulation data from the GIS, and send to the 3D printing device; the 3D printing device may print a pre-disaster physical simulation sand table based on the initial topographic data, print a post-disaster physical simulation sand table based on the simulation data, and conduct a simulation verification experiment based on the pre-disaster physical simulation sand table; a high-velocity camera may be used to record the process of the simulation verification experiment, and a miniature water velocity meter may be placed at downstream key locations to record an actual flood peak discharge; and the processor may compare an actual breach obtained from the simulation verification experiment to a simulated breach in the post-disaster physical simulation sand table and determine whether the actual breach is consistent with the simulated breach to verify whether the simulation result is correct.

The simulation result includes topographic data of the final terrain eroded by the flood as simulated by the depth-averaged mixed flow model.

The simulation verification experiment is used to verify the simulation result of the depth-averaged mixed flow model. In some embodiments, the simulation verification experiment includes: laying different simulation materials (e.g., sand, small stones) on the pre-disaster physical simulation sand table based on the particle size distribution data, and laying landslide mass and dam materials; placing the pre-disaster physical simulation sand table in the flume, and configuring the simulation materials (e.g., a sand-stone mixture in a corresponding proportion) according to the volume fraction of the coarse particles and the volume fraction of the fine particles in the simulation data; and rapidly dumping the simulated materials at a location of landslide source to impact a lake (i.e., a water retention area in the flume).

In some embodiments, the processor may determine that the simulation result is correct in response to a characteristic parameter of the actual breach and a characteristic parameter of the simulated breach satisfy a first preset condition, and the actual flood peak discharge and the downstream flood peak discharge satisfy a second preset condition; and adjust the cohesion and the pore water pressure ratio of the bed particles based on the surge erosion characteristics observed in the hydraulic simulation.

The characteristic parameter includes a location, a size, a depth of the breach, etc.

In some embodiments, the characteristic parameter of the actual breach may be obtained by measuring the breach in the pre-disaster physical simulation sand table after the simulation is completed. The characteristic parameters of the simulated breach may be obtained by measuring the breach in the post-disaster physical simulation sand table.

The first preset condition may be that a difference between the characteristic parameter of the actual breach and the characteristic parameter of the simulated breach is less than a first preset threshold. The second preset condition may be that a difference between the actual flood peak discharge and the downstream flood peak discharge is less than a second preset threshold. The first preset threshold and the second preset threshold may be set based on experience.

The surge erosion characteristics refer to characteristics of the scouring, impact, and destructive effects on the moraine dam produced by the giant water wave formed when the landslide mass rushes into the glacier lake at high velocity.

In some embodiments, the surge erosion characteristics include a stripping strength, a breach expansion pattern, a pore water pressure response, etc.

The stripping strength refers to an intensity of particle detachment when the surge wave impacts the surface layer of the dam. In some embodiments, the stripping strength is negatively correlated with the motion velocity of the solid particles on the surface of the dam. In some embodiments, the processor may acquire an image of the dam surface captured by the high-speed camera and determine a motion velocity of the particles on the dam surface through an image analysis technique.

The breach expansion pattern reflects a dynamic evolution law of the gap formed in the dam after erosion in different directions.

In some embodiments, the processor may obtain 3D data of the breach at key time points (e.g., 1 minute, 5 minutes, 10 minutes after the breach) during the actual hydraulic simulation process via a fast 3D scanner or stereo photogrammetry; and extract a change curve in the width and depth of the breach over time based on the 3D data to characterize a breach expansion pattern.

The pore water pressure response reflects a perturbation effect on the water pressure distribution in the interstices between the dam particles after the water carried by the surge wave infiltrates into the dam. In some embodiments, when making the physical simulation sand table, an array of miniature pore water pressure sensors may be buried at a plurality of monitoring points at different depths and at different locations within the moraine dam, thereby obtaining a change curve of a pore water pressure over time at the monitoring points to characterize the pore water pressure response.

In some embodiments, the processor may adjust the total erosion rate of the mixed flow every a preset period (e.g., 3 minutes) based on the surge erosion characteristics observed in the hydraulic simulation via a first preset table.

The first preset table includes a mapping relationship between the surge erosion characteristics, a current cohesion of the bed particles, a current pore water pressure ratio, an adjusted cohesion of the bed particles, and an adjusted pore water pressure ratio. The first preset table may be determined based on experience or historical data.

In some embodiments, the first preset table may be set based on manual experience. For example, the cohesion is reduced when particle stripping is observed to accelerate, thereby allowing the model to more closely match the actual soil looseness. As another example, the pore water pressure ratio is increased when a sudden rise in pore water pressure is monitored. The cohesion is cranked up and the pore water pressure ratio is lowered when a width growth rate of the breach expansion pattern is greater than a depth growth rate of the breach expansion pattern, thereby matching the composite erosion pattern.

In some embodiments of the present disclosure, the problems of numerical simulation “black-box operation” and the credibility validation are resolved through testing and calibrating the model by the physical simulation sand table and hydraulic simulation. By feeding the observed surge erosion characteristics back into the core equations of the model, deep optimization of the underlying algorithms of the model is achieved, which provides the system with the ability to learn and evolve.

In some embodiments, the processor may generate an engineering prevention and control instruction in response to an existence of a dam failure risk in the verification of the hydraulic simulation; send the engineering prevention and control instruction to the 3D printing device and control the 3D printing device to prepare a protective structural component; and send the engineering prevention and control instruction to a terminal of an engineer, and reinforcing, by the engineer, the moraine dam based on the engineering prevention and control instruction.

The engineering prevention and control instruction refers to an instruction related to preventing and controlling the dam failure risk.

In some embodiments, the processor may determine that the dam failure risk exists in response to a falling speed of an elevation the moraine dam during the hydraulic simulation process being greater than a preset speed threshold and generate the engineering prevention and control instruction. The preset speed threshold may be set manually. In some embodiments, the falling speed of the elevation the moraine dam may be obtained via a high-definition camera

The engineer refers to a staff who protects and manages the glacier lake hazard. The terminal of the engineer may be a cell phone, a personal computer, a tablet, etc.

In some embodiments, reinforcing the moraine dam may include laying a permeable layer in a bottom layer of the moraine dam, filling voids with fine particles (with particle size less than 2 mm) in a middle layer of the moraine dam, covering an upper layer of the moraine dam with coarse particles (with particle size greater than 20 mm), and covering a surface layer of the moraine dam with original dam fine soil.

Th protective structural component refers to a high-strength concrete element used to reinforce the dam.

In some embodiments, preparing the protective structural component may include obtaining a printing parameter of the 3D printing device; performing 3D printing to obtain the protective structural component based on the printing parameter; and deploying the protective structural component in a downstream channel of the moraine dam.

The printing parameter includes a component category and an impact resistance strength of the protective structural component. The component category refers to a category of the protective structural component, for example, a curved impact resistant pile, a diversion baffle, etc. The component category may be preset based on requirements.

The impact resistance strength refers to ability of the protective structural component to resist scouring, erosion, and damage under impacts of high-velocity water flow, debris flow, etc. More descriptions regarding the manner of determining the impact resistance strength may be found in the related descriptions below.

In some embodiments of the present disclosure, the internal drainage of the dam, the blocking of particle loss, and the resistance to scouring of the water flow can be realized by reinforcing the moraine dam; and the impact of the downstream channel flood after the glacier lake outburst can be counteracted by the protective structural component. By reinforcing moraine dam and preparing protective structural component, a dual defense system of internal reinforcement and external protection can be achieved, allowing optimal and tailored engineering interventions to be generated and deployed quickly and efficiently.

In some embodiments, the processor may determine an inverted layer gradation of the moraine dam based on particle size distribution data of at least one of the fine particles and the coarse particles; and determine the impact resistance strength of the protective structural component based on the flow velocity of the mixed flow along the second direction.

The inverted layer refers to one or more layers of permeable material consisting of coarse sand, gravel, etc. laid inside the moraine dam. In some embodiments of the present disclosure, the inverted layer enables rapid drainage to reduce the infiltration pressure to protect the dam and filters the fine particles to prevent piping, thereby maintaining a balance between the drainage and the soil preservation to ensure the stability of the dam.

The gradation refers to a combination ratio of different size particles in particles such as sand and gravel.

In some embodiments, the processor may obtain the particle size of the fine particles via the UAV to estimate an average particle size of the fine particles; and determine the inverted layer gradation based on geotechnical experience (e.g., Terzaghi's criterion).

In some embodiments, an average particle size of the inverted layer gradation may be 8-12 times of the average particle size of the fine particles.

When the protective structural component is a concrete structure, the impact resistance strength is positively correlated with a standard strength level of the concrete of the protective structural component.

In some embodiments, the processor may obtain a maximum flow velocity in which the landslide impacts a slope of the dam from the simulation result of the depth-averaged mixed flow model; classify a risk level corresponding to the maximum flow velocity; and determine the standard strength level of the concrete based on the risk level.

In some embodiments, the processor may classify a maximum flow velocity less than a first flow velocity threshold as a low-velocity impact; classify a maximum flow velocity located between the first flow velocity threshold and a second flow velocity threshold as a medium-velocity impact; and classify a maximum flow velocity greater than the second flow velocity threshold as a high-velocity impact. The first flow velocity threshold is less than the second flow velocity threshold, and the first flow velocity threshold and the second flow velocity threshold may be set empirically. For example, the first flow velocity threshold is 5 m/s, and the second flow velocity threshold is 15 m/s.

In some embodiments, the standard strength level of the concrete is positively correlated with the risk level. For example, the protective structural component corresponding to the low-velocity impact may adopt concrete of grade C25, the protective structural component corresponding to the medium-velocity impact may adopt concrete of grade C30 or grade C35, and the protective structural component corresponding to the high-velocity impact may adopt concrete of grade C40 or higher.

In some embodiments of the present disclosure, by determining the inverted layer gradation of the moraine dam and the impact resistance strength of the protective structural components, the safety and stability of the project can be improved, and the resource waste is also avoided by optimizing the allocation of the materials, thereby realizing dual improvement of the economy and reliability of the project.

In some embodiments, the simulation data further includes meteorological forecast data.

The meteorological forecast data refers to predictive information of future weather changes generated based on the laws of atmospheric motion. In some embodiments, the meteorological forecast data may include a precipitation forecast, a temperature change trend, a wind change trend, a humidity state, etc.

In some embodiments, the meteorological forecast data may be obtained through multi-source collaborative observations such as the satellite remote sensing (e.g., meteorological satellites), the UAV aerial survey, and the surface sensor network. For example, a rainfall area and a rainfall period are determined by the meteorological satellites; a local rainfall intensity distribution is corrected by capturing a wind direction, a wind velocity, a sign of snow melting, and an effect topography on the airflow in the target area via the UAV; and the micro-data such as a rainfall intensity, a soil humidity, etc. at key points such as a hillside or a lake are provided via the surface sensor network in real time.

In some embodiments of the present disclosure, the introduction of meteorological forecast data into the simulation data extends the predictive capability of the depth-averaged mixed flow model from purely geographic and geologic factors to dynamic meteorological dimensions, thereby predicting the real-time impact of weather changes on disaster risk.

In some embodiments, the processor may determine a cohesion parameter of the bed particles and the pore water pressure ratio based on the meteorological forecast data.

In some embodiments, the processor may determine the cohesion parameter and the pore water pressure ratio of the bed particles based on the meteorological forecast data via a second preset table.

In some embodiments, the second preset table includes a mapping relationship between the meteorological forecast data, the cohesion parameter of the bed particles, and the pore water pressure ratio.

In some embodiments, the second preset table may be obtained based on manual experience. For example, the cohesion requires to be increased and the pore water pressure ratio requires to be decreased when there is a moderate rainfall accompanied by rapid cooling to sub-zero.

In some embodiments of the present disclosure, by adjusting the cohesion parameter and the pore water pressure ratio of the sub-bed particles by weather forecast data, it quantifies the effect of rainfall on soil stability, which can more realistically simulate the behavior of soils under extreme weather, thereby providing a more accurate and reliable disaster risk assessment.

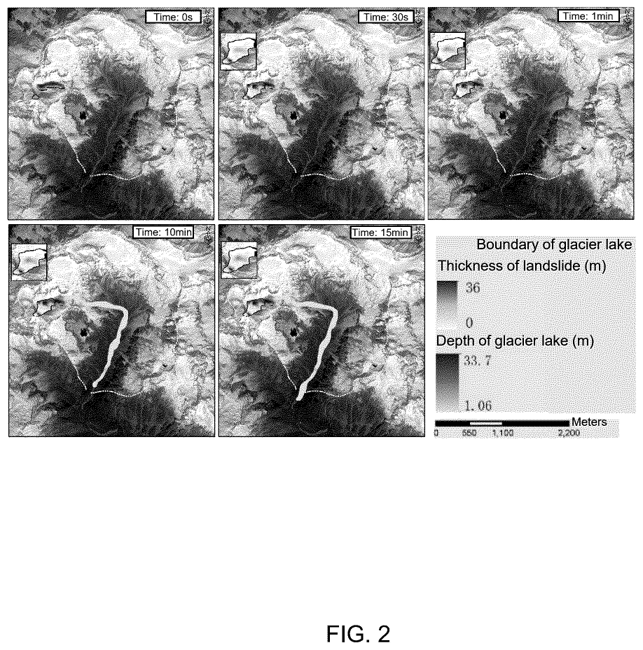

FIG. 2 is an exemplary schematic diagram illustrating a simulation result of the numerical simulation of the disaster chain from landslide and surge wave to glacier lake outburst according to some embodiments of the present disclosure.

In some embodiments, a landslide approximately has a length of 150 m, a width of 70 m, a thickness of 60 m, and a volume of 1.1 million m³. A downstream of the landslide is a glacier lake, and a drop from a location of the landslide to the surface of the glacier lake is roughly 240 m. In the landslide mass, the initial volume fraction of coarse particles is 35%, the initial volume fraction of fine particles is 25%, and the initial volume fraction of water is 5%. The second friction angle between coarse particles in mixed flow and bed is 30°, the first friction angle between unsaturated fine particles in mixed flow and bed is 25°, the empirical coefficient α_{σ} is 0.1, the empirical coefficient m is 0.8, the turbulence coefficient of the coarse particles is 30.0 m^{1/2}/s, and Manning coefficient is 0.05 s/m^{1/3}. The overflow velocity of the air in the mixed flow is 0.05 m/s, and the volume fraction of the gas-phase medium in the erodible channel bed α_{ba} is 0.15; the volume fraction of fine particles in the erodible channel bed α_{bf} is 0.24; the volume fraction of coarse particles in the erodible channel bed α_{bc} is 0.36; and the volume fraction of the liquid-phase medium (e.g., water) in the erodible channel bed α_{bw} is 0.25. The empirical coefficient α₁ is 0.55, the empirical coefficient β₁ is 10.4, the empirical coefficient α₂ is 0.18, the empirical coefficient β₂ is 24.6, the pore water pressure ratio of the bed particles λ is 0.8, and the friction angle of the bed particles φ_{bed} is 32°, the cohesion of the bed particles C is 12500 Pa, the grid size of the terrain in the first direction is 12.5 m, the grid size of the terrain in the second direction is 12.5 m, the density of water ρ_{w}=1000 kg/m³, the density of the coarse particles and the fine particles ρₛ=2650 kg/m³, and the density of air ρₐ=1.29 kg/m³. The above parameters are inputted into the depth-averaged mixed flow model for computation, and the results of the dynamic distribution of the landslide depth and the glacier lake flood depth at different moments are obtained as the simulation results, which are shown in FIG. 2.

The basic concepts have been described above, and it is apparent to a person skilled in the art that the above detailed disclosure serves only as an example and does not constitute a limitation of the present disclosure. While not expressly stated herein, a person skilled in the art may be able to make various modifications, improvements, and amendments to the present disclosure. Such modifications, improvements, and amendments are suggested in the present disclosure, so such modifications, improvements, and amendments remain within the spirit and scope of the exemplary embodiments of the present disclosure.

Also, the present disclosure uses specific words to describe the exemplary embodiments of the present disclosure. Such as “an embodiment”, “one embodiment”, and/or “some embodiment” means a feature, structure, or characteristic associated with at least one embodiment of the present disclosure. Accordingly, it should be emphasized and noted that “one embodiment” or “one embodiment” or “a number of embodiments” referred to two or more times in different locations in the present disclosure do not necessarily refer to the same embodiment. In addition, certain features, structures, or characteristics in one or more embodiments of the present disclosure may be suitably combined.

Similarly, it should be noted that in order to simplify the presentation of the disclosure of the present disclosure, and thereby aid in the understanding of one or more embodiments of the present disclosure, the foregoing descriptions of the embodiments of the present disclosure sometimes combine a variety of features into a single embodiment, accompanying drawings, or a description thereof. In fact, the claimed subject matter may lie in less than all features of a single foregoing disclosed embodiment.

Numbers describing the number of components, attributes, and attributes are used in some embodiments, and it should be understood that such numbers used in the description of embodiments, in some examples, use the modifiers “about”, “approximately”, or “generally”. Unless otherwise noted, the terms “about,” “approximately,” or “generally” indicates that a ±20% variation in the stated number is allowed. Correspondingly, in some embodiments, the numerical parameters used in the specification are approximations, which can be varied depending on the desired characteristics of the individual embodiment. In some embodiments, the numerical parameters should take into account the specified number of valid digits and employ general place-keeping. While the numerical domains and parameters used to confirm the breadth of their ranges in some embodiments of the present disclosure are approximations, in specific embodiments such values are set to be as precise as possible within a feasible range.

For each of the patents, patent applications, patent application disclosures, and other materials cited in the present disclosure, such as articles, books, specification sheets, publications, documents, etc., the entire contents thereof are hereby incorporated herein by reference. Application history documents that are inconsistent with or conflict with the contents of the present disclosure are excluded, as are documents (currently or hereafter appended to the present disclosure) that limit the broadest scope of the present disclosure. It should be noted that in the event of any inconsistency or conflict between the descriptions, definitions, and/or use of terms in the materials appended to the present disclosure and those set forth herein, the descriptions, definitions and/or use of terms in the present disclosure shall prevail.

Finally, it should be understood that the embodiments described in the present disclosure are used only to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A numerical simulation method of a disaster chain from landslide and surge wave to glacier lake outburst, comprising:
obtaining simulation data required by a numerical simulation algorithm based on a depth-averaged mixed flow model coupling a continuum mechanics algorithm with a mixed flow, wherein
the mixed flow includes a liquid-phase medium, a solid-phase medium, and a gas-phase medium, wherein the solid-phase medium includes fine particles and coarse particles, and
the simulation data includes at least one of topographic data, a location of landslide initiation, volume and depth information of the landslide initiation, a coarse particles content and a fine particles content in an initial stage of the landslide, a friction angle between the landslide and a bed, a coarse particles content and a fine particles content of the landslide in an erodible channel, a water depth distribution of a glacier lake, a bed roughness coefficient of surge and flood evolution, a coarse particles content and a fine particles content in a moraine dam, and a characteristic particle size of the coarse particles and a characteristic particle size of the fine particles in the moraine dam.

2. The method of claim 1, further comprising: obtaining the simulation data required for the numerical simulation algorithm based on satellite remote sensing, unmanned aerial vehicle (UAV) aerial survey, and a surface sensor network.

3. The method of claim 1, wherein the depth-averaged mixed flow model includes a mixed flow motion control equation, and the mixed flow motion control equation includes:
a first motion equation including a correlation between a first unit discharge of the mixed flow along a first direction, a second unit discharge of the mixed flow along a second direction, and a flow depth of the mixed flow, and a total erosion rate of the mixed flow;
a second motion equation including a correlation between the first unit discharge, the second unit discharge, the flow depth of the mixed flow, the total erosion rate of the mixed flow, a density of the mixed flow, a first bed resistance of the mixed flow along the first direction, and a topographic elevation required for simulation; and
a third motion equation including a correlation of the first unit discharge, the second unit discharge, the depth of the mixed flow, the total erosion rate of the mixed flow, the density of the mixed flow, a second bed resistance of the mixed flow along the second direction, and the topographic elevation required for the simulation.

4. The method of claim 3, wherein the first unit discharge is related to a first flow velocity of the mixed flow along the first direction and the flow depth of the mixed flow, and the second unit discharge is related to a second flow velocity of the mixed flow along the second direction and the flow depth of the mixed flow.

5. The method of claim 3, further comprising:
determining an erosion rate of the liquid-phase medium based on the flow depth of the mixed flow, the first unit discharge, the second unit discharge, and a volume fraction of the liquid-phase medium in the mixed flow;
determining an erosion rate of the solid-phase medium based on the flow depth of the mixed flow, the first unit discharge, the second unit discharge, and a volume fraction of the solid-phase medium in the mixed flow; and
determining an erosion rate of the gas-phase medium based on the flow depth of the mixed flow, the first unit discharge, the second unit discharge, a volume fraction of the gas-phase medium in the mixed flow, and an overflow velocity of the gas-phase medium in the mixed flow.

6. The method of claim 3, further comprising:
determining a preliminary prediction result of landslide risk in a target area based on initial topographic data of the target area and a landslide material content in a landslide mass;
generating an aerial survey instruction in response to the preliminary prediction result being that the target area includes a risk area; and
controlling an unmanned aerial vehicle (UAV) to conduct aerial survey on the risk area based on the aerial survey instruction, collecting particle size distribution data of at least one of the fine particles and the coarse particles in the risk area, and updating parameters of the depth-averaged mixed flow model.

7. The method of claim 3, further comprising:
determining the topographic elevation required for simulation based on the total erosion rate of the mixed flow.

8. The method of claim 3, further comprising:
determining the density of the mixed flow based on a density and a volume fraction of the liquid-phase medium, a density and a volume fraction of the solid-phase medium, and a density and a volume fraction of the gas-phase medium in the mixed flow.

9. The method of claim 3, further comprising:
determining the first bed resistance of the mixed flow along the first direction based on the density of the mixed flow, a first conversion parameter when flood transitions to underwater saturated landslide or debris flow, a first motion resistance of a fine particle mixture along the first direction, a second motion resistance of the coarse particles along the first direction, a Manning coefficient, the first unit discharge, and the second unit discharge, wherein the fine particle mixture includes the fine particles, the liquid-phase medium, and the gas-phase medium; and
determining the second bed resistance of the mixed flow along the second direction based on the density of the mixed flow, a transition conversion parameter, a third motion resistance of the fine particle mixture along the second direction, a fourth motion resistance of the coarse particles along the second direction, the Manning coefficient, the first unit discharge, and the second unit discharge.

10. The method of claim 9, wherein the first conversion parameter is related to a volume fraction of the fine particles in the mixed flow, a volume fraction of the coarse particles in the mixed flow, a critical total particle concentration, and a first attenuation parameter when the flood transitions to the underwater saturated landslide or the debris flow.

11. The method of claim 9, wherein the first motion resistance and the third motion resistance are related to a volume fraction and a density of the fine particles in the mixed flow, a volume fraction and a density of the liquid-phase medium in the mixed flow, a volume fraction and a density of the gas-phase medium in the mixed flow, the first unit discharge, the second unit discharge, the first flow velocity, the second flow velocity, the flow depth of the mixed flow, a suction stress between unsaturated fine particles, a cohesion between the unsaturated fine particles, a first friction angle, and a second conversion parameter for resistance conversion from unsaturated landslide to saturated landslide, respectively, wherein the first friction angle is a friction angle between the unsaturated fine particles in the mixed flow and the bed.

12. The method of claim 11, further comprising:
determining the second conversion parameter based on the volume fraction of the gas-phase medium in the mixed flow, a critical gas-phase volume fraction, and a second attenuation parameter for resistance conversion from the unsaturated landslide to the saturated landslide.

13. The method of claim 11, further comprising:
determining the suction stress between the unsaturated fine particles based on a volumetric water content, a residual water content, and a saturated water content between the fine particles; wherein
the volumetric water content between the fine particles is related to the volume fraction of the liquid-phase medium, the volume fraction of the fine particles, and the volume fraction of the gas-phase medium in the mixed flow.

14. The method of claim 9, further comprising:
determining the third motion resistance based on the density of the mixed flow, a density of the fine particle mixture, the first unit discharge, the second unit discharge, the first flow velocity, the second flow velocity, the depth of the mixed flow, a first slope of the mixed flow along the first direction, a second friction angle between the coarse particles in the mixed flow and the bed, a volume fraction and a turbulence coefficient of the coarse particles, and a density of the fine particles, wherein the density of the fine particle mixture is related to the density and a volume fraction of the fine particles, a density and a volume fraction of the liquid-phase medium, and a density and a volume fraction of the gas-phase medium.

15. The method of claim 14, further comprising:
determining the fourth motion resistance based on the density of the mixed flow, the density of the fine particle mixture, the first unit discharge, the second unit discharge, the first flow velocity, the second flow velocity, the flow depth of the mixed flow, a second slope of the mixed flow along the second direction, the second friction angle, the volume fraction and the turbulence coefficient of the coarse particles, and the density of the fine particles.

16. The method of claim 4, further comprising:
determining the total erosion rate of the mixed flow based on the flow depth of the mixed flow, the density of the mixed flow, the first bed resistance, the second bed resistance, the first flow velocity, the second flow velocity, the first unit discharge, the second unit discharge, a pore water pressure ratio, a channel bed slope of the mixed flow, and a friction angle and a cohesion of bed particles;
wherein the channel bed slope of the mixed flow is related to a third slope of the bed along the first direction and a fourth slope of the bed along the second direction, and the third slope and the fourth slope are related to a grid size and a topographic elevation of a grid.

17. The method of claim 16, further comprising:
determining whether a risk exists based on a simulation result of the depth-averaged mixed flow model;
generating an actual simulation instruction in response to an existence of the risk;
sending the practical simulation instruction to a 3D printing device, controlling the 3D printing device to produce a physical simulation sand table, and performing a hydraulic simulation based on the physical simulation sand table to verify the existence of the risk; and
adjusting the cohesion of the bed particles and the pore water pressure ratio based on surge erosion characteristics observed in the hydraulic simulation.

18. The method of claim 17, further comprising:
generating an engineering prevention and control instruction in response to an existence of a dam failure risk in the verification of the hydraulic simulation;
sending the engineering prevention and control instruction to the 3D printing device and controlling the 3D printing device to prepare a protective structural component; and
sending the engineering prevention and control instruction to a terminal of an engineer, and reinforcing, by the engineer, the moraine dam based on the engineering prevention and control instruction.

19. The method of claim 3, wherein the simulation data further includes meteorological forecast data.

20. The method of claim 16, further comprising:
determining an erosion rate of the gas-phase medium in the mixed flow based on the total erosion rate of the mixed flow and a volume fraction of the gas-phase medium in an erodible channel bed;
determining an erosion rate of the fine particles in the mixed flow based on the total erosion rate of the mixed flow and a volume fraction of the fine particles in the erodible channel bed;
determining an erosion rate of the coarse particles in the mixed flow based on the total erosion rate of the mixed flow and a volume fraction of the coarse particles in the erodible channel bed; and
determining an erosion rate of the liquid-phase medium in the mixed flow based on the total erosion rate of the mixed flow and a volume fraction of the liquid-phase medium in the erodible channel bed.
